(19) United States
(12) Patent Application Publication
(10) Pub. No.: US 2026/0085935 A1
(43) Pub. Date: Mar. 26, 2026

(54) APPARATUS AND METHOD FOR ESTIMATING AZIMUTH

(71) Applicant: Hansung University Industry-University Cooperation Foundation, Seoul (KR)

(72) Inventor: Jongtaek Oh, Seoul (KR)

(73) Assignee: Hansung University Industry-University Cooperation Foundation, Seoul (KR)

(21) Appl. No.: 19/209,709

(22) Filed: May 15, 2025

Related U.S. Application Data
(60) Provisional application No. 63/648,106, filed on May 15, 2024.

(51) Int. Cl. G01C 21/16; G06N 3/08

(52) U.S. Cl. CPC G01C 21/1654; G06N 3/08

(57) ABSTRACT

Provided are an azimuth estimation apparatus and an azimuth estimation method. The azimuth estimation apparatus includes a processor performing a plurality of operations including: acquiring acceleration values, angular velocity values, and geomagnetic values in different directions while the azimuth estimation apparatus rotates at a first location; acquiring a rotation angle value of the azimuth estimation apparatus based on the acceleration values and angular velocity values; acquiring sampled geomagnetic values by sampling the geomagnetic values based on the rotation angle value; estimating an azimuth at the first location based on the sampled geomagnetic values; training a neural network-based azimuth estimation model based on the sampled geomagnetic values and the estimated azimuth; and estimating an azimuth at a second location using the trained azimuth estimation model.

### BACKGROUND

The present disclosure relates to an azimuth estimation apparatus and an azimuth estimation method.

Research is being conducted on methods for estimating azimuth by measuring the magnetic field. In the technical field related to a signal generation device that transmits a signal to a terminal, studies are underway on methods of generating, as a signal, information including absolute coordinates and an installation azimuth angle, together with a signal for estimating the position of the terminal, so that the terminal itself can also estimate its position.

### SUMMARY

In accordance with an embodiment, an azimuth estimation apparatus may include a memory storing instructions and a processor operably coupled to the memory and configured to execute the instructions. When the instructions are executed by the processor, the processor may perform a plurality of operations including: acquiring an acceleration value, an angular velocity value, and geomagnetic values in different directions of the azimuth estimation apparatus while the azimuth estimation apparatus rotates at a first location; obtaining a rotation angle value of the azimuth estimation apparatus based on the acceleration value and the angular velocity value; acquiring sampled geomagnetic values by sampling the geomagnetic values based on the rotation angle value; estimating an azimuth at the first location based on the sampled geomagnetic values; calculating a true azimuth by adding the rotation angle to an initial azimuth of the azimuth estimation apparatus at the first location; training a neural network-based azimuth estimation model based on the sampled geomagnetic values and the estimated azimuth; and estimating an azimuth at a second location using the trained azimuth estimation model.

In accordance with another embodiment, a method for estimating an azimuth, performed by an azimuth estimation apparatus, may include: acquiring an acceleration value, an angular velocity value, and a geomagnetic value for different directions of the azimuth estimation apparatus while the azimuth estimation apparatus rotates at a first location; acquiring a rotation angle value of the azimuth estimation apparatus e based on the acceleration value and the angular velocity value; acquiring sampled geomagnetic values by sampling the geomagnetic value based on the rotation angle value; estimating an azimuth at the first location based on the sampled geomagnetic values; training a neural network-based azimuth estimation model based on the sampled geomagnetic values and the azimuth; and estimating an azimuth at a second location using the trained azimuth estimation model.

### BRIEF DESCRIPTION OF THE DRAWINGS

FIG. 1 is a diagram for illustrating an azimuth estimation apparatus and method.

FIG. 2 is a block diagram showing a user of an azimuth estimation apparatus according to an embodiment.

FIG. 3 is a flowchart for illustrating an azimuth estimation method according to an embodiment.

FIG. 4 is a diagram illustrating a graph of magnetic field values measured by the azimuth estimation apparatus according to an embodiment.

FIG. 5 is a diagram for illustrating training data used to train an azimuth estimation model according to an embodiment.

FIG. 6 is a diagram for illustrating operations of the azimuth estimation model according to an embodiment.

### DETAILED DESCRIPTION OF EMBODIMENTS

The present disclosure provides an azimuth estimation apparatus and an azimuth estimation method capable of improving the reliability of an azimuth estimation model to accurately estimate an azimuth.

In particular, azimuth estimation at a current location is performed through the following operations: i) measuring magnetic field data while rotating 360 degrees from the current heading direction at the current location; ii) generating an estimated azimuth data set by calculating azimuth data for each predetermined rotation angle using the measured magnetic field data; and iii) estimating the azimuth at the current location by applying the estimated azimuth data set to a trained azimuth estimation model.

In addition, the azimuth estimation model is generated and trained through the following operations. At a specific location: i) orienting in a specific direction (e.g., magnetic north at 0 degrees) and measuring magnetic field data while rotating 360 degrees from the oriented direction; ii) generating a base training azimuth data set by calculating azimuth data for each predetermined rotation angle using the measured magnetic field data; iii) generating multiple training azimuth data sets using the base training azimuth data set; and iv) training and generating the azimuth estimation model using the generated multiple training azimuth data sets. This azimuth estimation model training process may be performed at multiple locations to continuously train the azimuth estimation model, store it in an associated server, or share it among associated terminals, with continuous updates. The azimuth of a terminal is estimated using the azimuth estimation model whose reliability has thus been improved.

Accurate azimuth calculation may be used for correct orientation recognition and operation of a device in various technical fields, such as autonomous driving, drone control, communications, and location-based services.

Hereinafter, the azimuth estimation apparatus and method according to an embodiment will be described in detail.

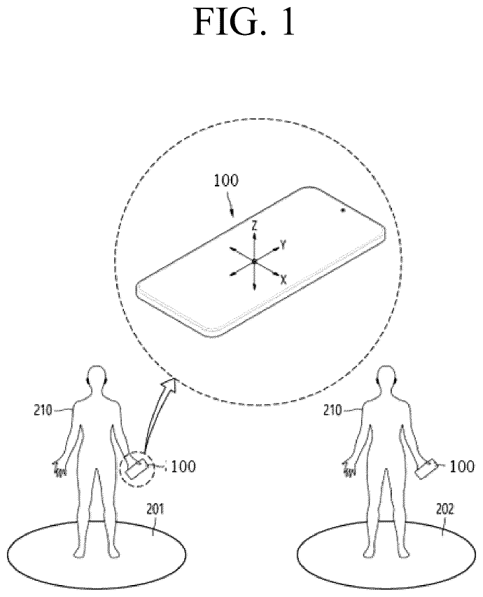

FIG. 1 is a diagram for illustrating an azimuth estimation apparatus and method according to an embodiment. Referring to FIG. 1, the azimuth estimation apparatus 100 trains and generates an azimuth estimation model at an arbitrary location 201. Using the generated model, the azimuth estimation apparatus 100 estimates an azimuth—defined as an angle, with respect to a horizontal plane, indicating the direction in which a user or the azimuth estimation apparatus 100 is facing—at another location 202. The azimuth estimation apparatus 100 is connected, via a communication network, to a server that manages the azimuth estimation model.

If the azimuth is inaccurate, various problems such as reduced safety, communication errors, and user confusion may occur. Therefore, accurate azimuth calculation is essential in various technical fields, including autonomous driving, drone control, communications, and location-based services.

Typically, azimuth is estimated in the following manner.

At the current location (201 or 202), magnetic fields in different directions are sensed to obtain magnetic field values for the respective directions. The obtained magnetic field values may include magnetic field values in a first direction, a second direction, and a third direction, which are mutually perpendicular. The first, second, and third directions may respectively correspond to the x-axis, y-axis, and z-axis in an orthogonal coordinate system having the position of the azimuth estimation apparatus as its origin. For example, the magnetic field values may be represented as (mₓ, m_{y}, m_{z}), where mₓ may indicate a magnetic field value in the first direction (e.g., x-axis) obtained by the sensor assembly 120, m_{y} may indicate a magnetic field value in the second direction (e.g., y-axis) perpendicular to the first direction, and m_{z} may indicate a magnetic field value in the third direction (e.g., z-axis) perpendicular to the second direction.

The azimuth Y′ may be estimated by substituting the obtained magnetic field values mₓ and m_{y} into Equation (1) below.

$$Ψ = - {tan}^{- 1} ( \frac{{m}_{y}}{{m}_{z}} ) \qquad [ Equation 1 ]$$

The Earth's magnetic field arises from various sources and is not uniform across different locations on the Earth's surface. The phenomenon in which the direction of the magnetic field varies depending on the location is referred to as magnetic declination. That is, magnetic declination refers to the deviation that occurs because the magnetic meridian indicated by a compass-does not align with the true geographic meridian. When the magnetic meridian is tilted westward relative to the true meridian, it is called west declination, and when tilted eastward, it is called east declination. In Korea, there is a magnetic declination of approximately 5° to 7° west from true north. In addition, the magnetic field may be distorted by artificial steel structures or geological features in the region, resulting in variations in the measured magnetic field values depending on the measurement location.

In addition, the magnetic north—indicated by the Earth's magnetic field—and the true north—the geographic North Pole—do not exactly coincide, and this difference may gradually change over time. For this reason, many countries measure local magnetic field values or provide models and formulas that can predict magnetic field values based on geographic location.

Due to these characteristics, the magnetic field values obtained by the magnetic field sensor 122 included in the azimuth estimation apparatus 100 may contain errors depending on the location of the apparatus, surrounding external structures (e.g., steel reinforcements in buildings), or geographical features. For example, if there is a steel structure near the apparatus, magnetic interference may occur, which may prevent the magnetic field sensor 122 from measuring accurate values.

Such interference may reduce the accuracy of the magnetic field values measured in each direction by the sensor, and as a result, may also lower the accuracy of the azimuth calculated by the azimuth estimation apparatus 100.

Therefore, to improve the accuracy of azimuth estimation, in the present embodiment, a large amount of azimuth data is generated and used to create and train an azimuth estimation model, and the trained model is then used to estimate the azimuth at an arbitrary location. That is, the azimuth estimation apparatus estimates the azimuth using the method described below in order to enhance azimuth estimation accuracy.

Referring to FIG. 1, the azimuth estimation apparatus according to an embodiment performs the following azimuth estimation model training operations. i) At the location 201, without moving, the apparatus rotates 360 degrees from a predefined heading direction (e.g., 0 degrees toward magnetic north) and measures magnetic field data at 1-degree intervals; ii) the measured magnetic field data is corrected; iii) based on the corrected magnetic field data, azimuths are calculated for each predefined rotation angle to generate a base training azimuth data set; iv) multiple training azimuth data sets are generated from the base training azimuth data set; and v) the azimuth estimation model is trained and generated using the multiple training azimuth data sets. These operations are referred to as azimuth estimation model training operations. This training process may be repeatedly performed at various different locations to continuously train the azimuth estimation model. The process may be executed by multiple associated terminals, which may share and integrate their respective trained estimation models. The integrated model may be stored and managed by an associated server and provided in response to requests from the associated terminals.

In one embodiment, the trained and generated azimuth estimation model is used to estimate an azimuth in a specific area. For example, in a specific region, the azimuth estimation apparatus rotates from an arbitrary heading direction at a location 202, detects magnetic field values (mₓ, m_{y}, m_{z}), pitch, roll, and angular velocity, and generates an estimated azimuth data set based on the detected information. This data set is then input into the azimuth estimation model to calculate the azimuth at the specific location 202. These operations are referred to as azimuth estimation operations.

Referring to FIG. 1, the following describes in more detail (a) the azimuth estimation model training operation and (b) the azimuth estimation operation. According to one embodiment, the azimuth estimation apparatus performs (a) the azimuth estimation model training operation and (b) the azimuth estimation operation in response to a predefined event or an input signal.

That is, the azimuth estimation apparatus 100 receives a signal that instructs a specific operation. This signal may be received from another terminal, may be input by a user through a specific input means, or may be a signal that is generated at predetermined intervals or when the movement or rotation of the azimuth estimation apparatus meets certain predefined conditions.

For example, if the received signal is a predefined event signal (e.g., during an initial stage or at a specific interval), the azimuth estimation model training operation is performed as follows.
i) The azimuth estimation apparatus 100 senses the magnetic field in three mutually perpendicular directions at a first location 201 and obtains magnetic field values corresponding to the first through third directions (mₓ, m_{y}, m_{z}).
ii) The azimuth estimation apparatus 100, without moving from the first location 201, rotates 360 degrees from a specific heading direction (e.g., 0 degrees toward magnetic north) and senses acceleration, angular velocity, and magnetic field to obtain acceleration values, angular velocity values, and magnetic field values. (In other embodiments, the rotation may be performed over a predetermined angle less than 360 degrees.)
iii) The azimuth estimation apparatus 100 obtains a rotation angle value based on the acceleration values and angular velocity values acquired at the first location 201.
iv) The azimuth estimation apparatus 100 samples magnetic field values at regular rotation angle intervals (e.g., at 1-degree intervals) based on the rotation angle values obtained at the first location 201 and obtains the sampled magnetic field values. (In other embodiments, the sampling may be performed at different angle intervals instead of 1 degree.)
v) The azimuth estimation apparatus 100 corrects the sampled magnetic field values and, using the corrected magnetic field values, calculates an azimuth for each predetermined rotation angle to generate a base training azimuth data set. For example, the base training azimuth data set may include mₓ, m_{y}, m_{z} values measured at 1-degree rotation intervals starting from the north, the calculated azimuth −tan⁻¹(m_{y}/mₓ) and a measured azimuth (label azimuth, or an azimuth measured by another device such as a compass). (In some embodiments, the magnetic field correction process may be omitted.)
vi) The azimuth estimation apparatus generates multiple training azimuth data sets by shifting the base training azimuth data set at fixed intervals such that the azimuth data of the first rotation angle (or heading angle of 0 degrees) is replaced with that of the next rotation angle (e.g., 1 degree or 359 degrees). (In the present embodiment, a 1-degree shift is used for explanation purposes; however, the shift interval is not limited to this value.)
vii) The azimuth estimation model, based on a neural network, is trained using the multiple training azimuth data sets. When the rotation angles are measured at 1-degree intervals, the neural network-based azimuth estimation model includes 360 input nodes. The data corresponding to each rotation angle in the training azimuth data set is input to the respective nodes, and the model is trained by outputting the difference between the measured azimuth and the estimated azimuth. Once training is complete, all edges in the model are assigned specific weights.

This azimuth estimation model training operation may be executed at predefined locations or at fixed time intervals. Alternatively, the initial azimuth estimation model training operation may be performed during the manufacturing of the azimuth estimation apparatus and then delivered to the user. It may also be automatically executed—such as every hour, after a certain period following movement to a new location, or during evening hours—to collect large amounts of data and train the azimuth estimation model. This training process may be repeatedly performed at different locations. Multiple associated terminals may carry out this process, allowing trained estimation models to be shared and integrated. During this process, the associated server may centrally store and manage the models and provide them in response to requests from the associated terminals.

In one embodiment, the azimuth estimation model training operation is performed at as many diverse locations as possible to acquire magnetic field data from various environments for use as neural network training data. By training the azimuth estimation model with such diverse data, the azimuth estimation error can be reduced when estimating the azimuth at an arbitrary location.

Using the trained azimuth estimation model, the azimuth estimation apparatus 100 can estimate the azimuth at an arbitrary second location 202.

For example, in a specific area, the azimuth estimation apparatus i) rotates 360 degrees in place from a heading direction while detecting magnetic field values (mₓ, m_{y}, m_{z}), pitch, roll, and angular velocity; ii) estimates an azimuth for each 1-degree rotation angle based on the detected information to generate a base azimuth data set; and iii) applies the base azimuth data set to the azimuth estimation model to estimate the azimuth at the specific location

In one embodiment, the azimuth estimation model may be fetched from the memory within the apparatus. In another embodiment, the model may be provided from another terminal via the communication unit. In yet another embodiment, the azimuth estimation model may be requested from an associated server, which manages and provides an updated version of the model.

In one embodiment, the associated server is connected, via a communication network, to multiple azimuth estimation apparatuses or terminals that include such apparatuses. The server receives, updates, and manages azimuth estimation models that have been generated and trained by the various apparatuses at different locations. The integrated and updated azimuth estimation model may also be provided in response to requests from the azimuth estimation apparatuses.

In addition, the associated server may manage magnetic declination information for various regions and may provide such information upon request from the azimuth estimation apparatuses.

In one embodiment, the estimated azimuth may be transmitted to another terminal or presented to the user through an output unit of the azimuth estimation apparatus.

In another embodiment, magnetic declination based on the coordinates of the current location may additionally be used when estimating the azimuth. The magnetic declination information may be provided by the associated server or may be stored in the memory of the azimuth estimation apparatus 100.

As previously described, the Earth's magnetic field arises from various sources, and the direction of magnetic north varies depending on the geographic location. This phenomenon is known as magnetic declination. Additionally, magnetic field distortion may occur due to artificial steel structures or local geological characteristics, resulting in even more irregular magnetic field values across different points. Magnetic north (i.e., the direction indicated by a compass) does not coincide with true north (i.e., the geographic North Pole), and this difference may change over time. Accordingly, many countries measure regional magnetic field values or provide model formulas and parameters that allow estimation of magnetic field values based on global coordinates.

By applying such a model, azimuth estimation accuracy can be improved by additionally using magnetic declination information corresponding to the coordinates of the location.

For example, the azimuth estimation apparatus 100 may transmit coordinate information and a magnetic declination request message to the associated server and receive the magnetic declination information for the corresponding location from the server. The azimuth estimation model may be stored in the azimuth estimation apparatus 100 or transmitted and stored in an associated server.

In one embodiment, the azimuth estimation apparatus 100 may receive a signal instructing it to perform an azimuth estimation operation. This signal may be received from another terminal or input by a user via a specific input means.

Upon receiving an azimuth estimation operation signal, the azimuth estimation apparatus 100: i) fetches the trained azimuth estimation model; ii) rotates 360 degrees from the current heading direction at the present location while measuring magnetic field values, calculates the azimuth at each rotation angle, and generates an estimated azimuth data set; and iii) applies the fetched azimuth estimation model to the generated estimated azimuth data set to calculate the estimated azimuth at the current location. Additionally, magnetic declination information for the current location may be used to refine the azimuth estimation result. For example, by using the magnetic declination value corresponding to the current location, the estimated azimuth can be adjusted to compute the true azimuth (true north) by adding the difference between magnetic north and true north. The estimated azimuth data set includes values such as mₓ, m_{y}, m_{z} measured at 1-degree intervals from the apparatus's heading direction, and the calculated azimuth −tan⁻¹(m_{y}/mₓ).

The data corresponding to each rotation angle in the estimated azimuth data set is input into the 360 input nodes of the trained azimuth estimation model. The trained model outputs a magnetic azimuth as a real number.

The azimuth estimation value thus calculated may be provided to another terminal via the communication unit

Hereinafter, the azimuth estimation apparatus 100 that performs the azimuth estimation operation described above will be explained.

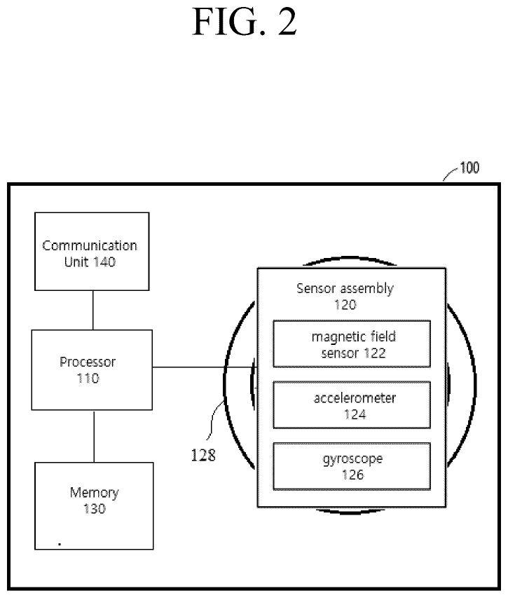

FIG. 2 is a block diagram illustrating the components of the azimuth estimation apparatus according to an embodiment of the present invention. In the present disclosure, the azimuth estimation apparatus is described as a standalone device dedicated to azimuth estimation; however, embodiments of the invention are not limited thereto. For example, the azimuth estimation apparatus may be implemented as a hardware module embedded in another terminal device or as a software application installed on a sensor-equipped terminal (e.g., a smartphone).

Referring to FIG. 2, the azimuth estimation apparatus 100 may include a processor 110, a sensor assembly 120, a memory 130, a communication unit 140, and an input/output circuit 150.

The processor 110 may be a hardware-based data processing device that includes circuits to perform desired operations. These operations may be defined by code or instructions included in a software program.

The hardware-based data processing device may include, for example, a microprocessor, a central processing unit (CPU), a processor core, a multi-core processor, a multiprocessor, an application-specific integrated circuit (ASIC), or a field-programmable gate array (FPGA).

In one embodiment, the processor 110 may perform one or more operations for azimuth estimation based on information and instructions stored in the memory 130. For example, the processor 110 may control each component of the azimuth estimation apparatus, process sensor data, and perform calculations to determine the azimuth based on the current location or environment. More generally, the processor 110 may be configured to coordinate the overall operation of the apparatus and execute various functions related to azimuth estimation.

The memory 130 may store instructions (or programs) executable by the processor 110. For example, the instructions may include operations for controlling the processor 110 and/or each component of the apparatus. The processor 110 may process data stored in the memory 130 or execute computer-readable code (e.g., software) and instructions stored therein.

In one embodiment, the memory 130 may store one or more instructions (or programs, applications, etc.) executable for azimuth estimation. The memory 130 may also store generated or trained azimuth estimation models. The method 130 may further store or maintain for reference related training data, configuration parameters, or prediction results. More generally, the memory 130 may include execution code and data resources that support the overall operation of the apparatus.

The communication unit 140 may be configured to perform data transmission and reception with other devices or network entities. For example, the communication unit 140 may include a transceiver or wireless communication module that exchanges information with nearby devices, base stations, or satellites.

In one embodiment, the communication unit 140 may receive azimuth estimation-related information from another terminal or provide estimated azimuth information and/or related data to another terminal. More generally, the communication unit 140 may be configured to bidirectionally exchange sensor data, orientation information, or model output values with external devices to support improved azimuth estimation accuracy or cooperative processing.

The communication unit 140 may receive magnetic declination information for the current location as part of training and estimation data and deliver it to the processor. This magnetic declination information may be used for training the azimuth estimation model. The input/output circuit 150 may be a circuit that receives input signals from the user or outputs azimuth estimation results and other related information. For example, the input/output circuit 150 may include components such as a touchscreen, buttons, LEDs, display, or other user interface elements installed in the device.

In one embodiment, the processor 110 may be connected to the sensor assembly 120 and may transmit control signals to the sensor assembly 120 in order to execute instructions for azimuth estimation.

The sensor assembly 120 may perform sensing operations according to the control signals received from the processor 110 and may include a magnetic field sensor 122, an accelerometer 124, and a gyroscope 126.

The magnetic field sensor 122 may sense the Earth's magnetic field at the current location of the azimuth estimation apparatus and acquire magnetic field values (e.g., mₓ, m_{y}, m_{z}) corresponding to different directions (x-, y-, and z-axis). These directions may be defined as orthogonal first, second, and third directions, which correspond to the x-, y-, and z-axes of an orthogonal coordinate system centered at the location of the azimuth estimation apparatus.

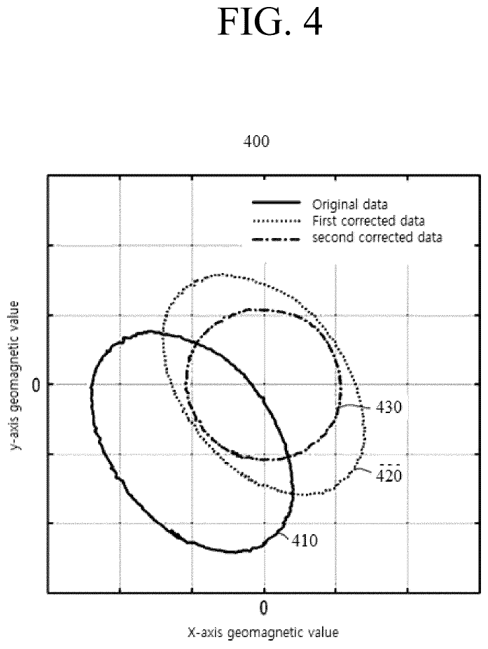

The magnetic field sensor 122 may transmit the sensed magnetic field values to the processor 110. The magnetic field values acquired by the magnetic field sensor 122 may contain errors depending on the measurement location, external structures (e.g., building walls), or terrain characteristics near the azimuth estimation apparatus. A decrease in the accuracy of magnetic field values may lead to a decrease in the accuracy of the azimuth estimation by the processor 110. Therefore, the processor 110 performs a correction operation for the magnetic field values. The correction operation performed by the processor 110 is described in detail in FIG. 4.

The accelerometer 124 may sense the acceleration of the azimuth estimation apparatus 100 and acquire acceleration values, which may include information related to pitch and roll rotation angles. The accelerometer 124 may transmit the acquired acceleration values to the processor 110.

The gyroscope 126 may sense the angular velocity of the azimuth estimation apparatus 100 and acquire angular velocity values, which can be transmitted to the processor 110. The gyroscope 126 is capable of sensing the angular velocity of the azimuth estimation apparatus 100.

The gyroscope 126 may sense the angular velocity of the azimuth estimation apparatus 100 to obtain angular velocity values and may transmit these values to the processor 110.

In one embodiment, the sensor assembly 120 may include a rotation driving member 128. Under the control of the processor 110, the rotation driving member 128 may rotate the sensor assembly 120 at a constant speed. The rotation driving member 128 may be implemented using various mechanical devices, such as a motor.

In one embodiment, the processor 110 may perform the following operations for azimuth estimation. Based on the acceleration values and angular velocity values acquired from the sensor assembly 120, the processor 110 may calculate the rotation angle of the azimuth estimation apparatus. Then, based on the acquired rotation angle values, the processor 110 may acquire magnetic field values at specific angular intervals and correct the acquired magnetic field values. Based on the corrected magnetic field values, the processor 110 may calculate the azimuth at each angular interval to generate a basic azimuth data set. The processor 110 may shift the data in the basic azimuth data set by a fixed interval to generate multiple azimuth training data sets (e.g., shifting by 1 degree to obtain 360 data sets). Using the multiple azimuth training data sets, the processor 110 may train a neural network-based azimuth estimation model.

As described above, the azimuth estimation apparatus 100 may be implemented using a MEMS (Micro-Electro Mechanical Systems) structure or a mechanical structure. In some cases, the processor 110 and the memory 130 may be integrated into a single component.

A key feature of the present invention is that the magnetic field sensor data is collected while rotating in place. Accordingly, the azimuth estimation apparatus 100 may include a rotation driving member 128 (e.g., a motor) that enables the magnetic field sensor to rotate at a constant speed to measure the magnetic field values.

Hereinafter, a detailed description will be given of the azimuth estimation method executed by the azimuth estimation apparatus 100.

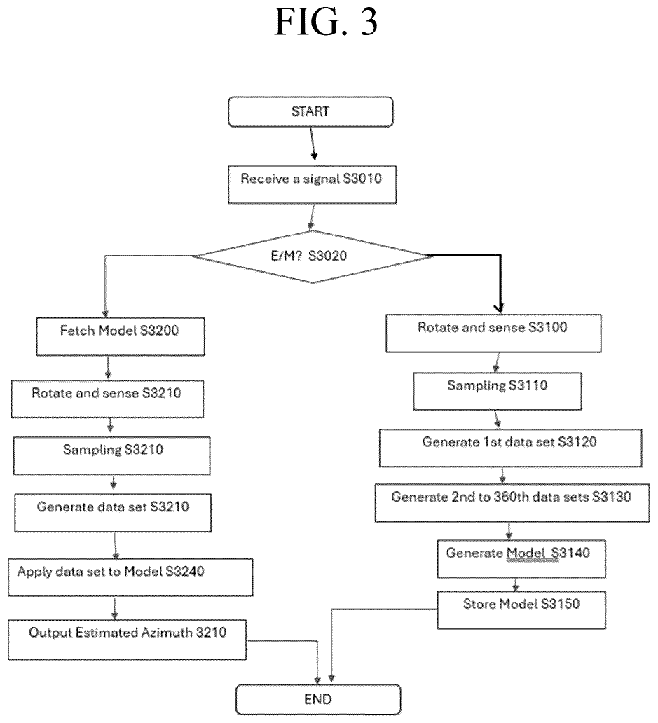

FIG. 3 is a flowchart illustrating the operations of an azimuth estimation method according to an embodiment. The sequence of operations shown in FIG. 3 is merely an example for explaining the azimuth estimation method and is not limited thereto. Two or more operations may be performed in parallel.

Referring to FIG. 3, the azimuth estimation apparatus 100 performs a) an azimuth estimation model training operation and b) an azimuth estimation operation as follows.

In step S3010, the azimuth estimation apparatus 100 receives an input signal from an external source.

In step S3020, the apparatus determines whether the input signal instructs to perform the azimuth estimation model training operation or the azimuth estimation operation.

In step S3020—Model, if the input signal instructs the azimuth estimation model training operation, the apparatus performs the model training operation as follows.

In step S3100, the azimuth estimation apparatus may rotate 360 degrees from a specific orientation (e.g., geomagnetic north direction: 0°, or an automatic direction: 90°) at a first location and acquire acceleration values of the azimuth estimation apparatus, angular velocity values of the azimuth estimation apparatus, and magnetic field values for different directions.

In step S3110, the azimuth estimation apparatus calculates the rotation angle of the apparatus based on the acquired acceleration and angular velocity values, and samples the magnetic field values at specific rotation angles to obtain sampled magnetic field data.

In step S3120, the azimuth estimation apparatus corrects the sampled magnetic field values using a predefined method to obtain corrected magnetic field values. Then, based on the corrected values, it estimates the corresponding azimuth for each rotation angle and generates a basic training azimuth data set (e.g., a first azimuth data set). Although correction of magnetic field values is described in this embodiment, other embodiments may omit the correction step.

In step S3130, the azimuth estimation apparatus shifts the basic training azimuth data set by a fixed interval (e.g., from 0 degrees to 1 degree or 356 degrees) to generate multiple azimuth training data sets.

In step S3140, the azimuth estimation apparatus generates and trains the azimuth estimation model using the multiple azimuth training data sets.

In other words, the basic training azimuth data set includes information measured at 1-degree rotation intervals starting from the north, such as mₓ, m_{y}, m_{z}, the calculated azimuth (e.g., −tan⁻¹(m_{y}/mₓ)), and the measured azimuth (i.e., the labeled azimuth obtained from a compass or another measurement device).

The neural network-based azimuth estimation model includes 360 input nodes, and the data associated with each rotation angle from the training azimuth data set is input into the corresponding nodes. The model is trained by minimizing the difference between the measured azimuth and the estimated azimuth. Once training is complete, each edge in the model will have a specific weight.

In step S3150, the trained azimuth estimation model is stored or provided.

This azimuth estimation model can be trained independently by multiple devices in different locations, and they can share their models with each other to improve accuracy further. In addition, each apparatus can send the trained model to a related server, where the models can be integrated and updated. The related server can also provide the latest updated model to apparatuses upon request.

In step S3020—Estimate, if the input signal instructs the azimuth estimation operation, the azimuth estimation procedure is performed as follows:

In step S3200, the azimuth estimation apparatus fetches the trained azimuth estimation model. That is, the apparatus can request and receive the model from a related server or another related apparatus. Alternatively, it can load the model stored in its memory.

In step S3210, the azimuth estimation apparatus rotates 360 degrees from its current orientation at the current location (e.g., second location 202) and obtains the apparatus's acceleration values, angular velocity values, and magnetic field values in different directions.

In step S3220, the azimuth estimation apparatus calculates the rotation angle values based on the obtained acceleration and angular velocity values. Then it samples magnetic field values at specific rotation angles to obtain the sampled magnetic field values.

In step S3230, the azimuth estimation apparatus corrects the sampled magnetic field values according to a predetermined method to obtain corrected magnetic field values. Based on the corrected values, the apparatus estimates the azimuth and generates an estimated azimuth data set (e.g., a first azimuth data set) based on the estimated azimuths corresponding to each rotation angle. For example, the estimated azimuth data set may include data such as mx, my, mz, −tan⁻¹(m_{y}/mₓ) (the calculated azimuth), measured at 1-degree intervals of rotation from the apparatus's heading angle.

In step S3240, the fetched azimuth estimation model is applied to the estimated azimuth data set to estimate the azimuth. For example, the data corresponding to each rotation angle included in the estimated azimuth data set is input to the 360 input nodes of the trained model, and the trained azimuth estimation model outputs the magnetic azimuth as a real number.

In another embodiment, information on magnetic declination may be held by an associated server. The server may store the magnetic declination information and use it to correct the azimuth. For example, the azimuth estimation apparatus 100 may transmit its current location information along with a magnetic declination information request message to the associated server and receive magnetic declination information corresponding to the current location. The azimuth estimation apparatus 100 may use the magnetic declination information to correct the estimated azimuth. In step S3220, the corrected azimuth may be provided.

Hereinafter, the azimuth estimation model training operation will be described in more detail.

The azimuth estimation model training operation may be performed when predetermined conditions are satisfied. For example, a signal instructing the azimuth training operation may be automatically generated and input when the azimuth estimation apparatus is initially powered on, after traveling a preset distance, or at predetermined time intervals. Alternatively, the signal may be received via a communication interface from an external terminal or be input by a user through an input/output circuit. This azimuth estimation model training process may be repeatedly performed at multiple different locations to continuously train the azimuth estimation model. This process may be executed by multiple associated terminals, which can share and integrate the trained estimation models. In such a case, the associated server may manage integrated storage and provide the models in response to requests from the associated terminals.

In step S3100, the azimuth estimation apparatus may acquire acceleration values, angular velocity values, and geomagnetic values in different directions while rotating 360 degrees at a specific orientation (e.g., magnetic north: 0 degrees, automatic direction: 90 degrees) without movement at a first location 201. The 360-degree rotation may be performed by a motor that rotates the sensor assembly 120.

That is, the processor 110 may acquire the rotation angle values of the azimuth estimation apparatus based on the acceleration and angular velocity values obtained from the sensor assembly 120.

In step S3110, the processor 110 may acquire geomagnetic values at every predetermined rotation angle based on the acquired rotation angle values.

For example, the processor 110 may sample the geomagnetic values at every 1° of rotation. Sampling geomagnetic values at regular rotation angles may prevent the sampled values from being biased toward a particular directional component.

That is, since the geomagnetic values can be sampled uniformly across all directions, training the azimuth estimation model based on geomagnetic values sampled at fixed rotation angles (e.g., every 1 degree) may improve the reliability and accuracy of the azimuth estimation model. In step S3120, the azimuth estimation apparatus corrects the sampled geomagnetic values, estimates the azimuth at each predetermined rotation angle (e.g., at 1-degree intervals) based on the corrected geomagnetic values, and generates a basic azimuth training dataset (D1). For example, the basic azimuth training dataset may include values measured at 1-degree rotation intervals from magnetic north, such as mₓ, m_{y}, m_{z}, the calculated azimuth value based on −tan⁻¹(m_{y}/mₓ), and a reference azimuth (i.e., labeled azimuth measured by a compass or another apparatus).

In one embodiment, the processor 110 may correct the sampled geomagnetic values to obtain corrected geomagnetic values. Accordingly, the processor 110 may perform operations for correcting the geomagnetic values. These correction operations performed by the processor 110 are described in detail with reference to FIG. 4.

FIG. 4 is a diagram showing a graph of geomagnetic values measured by the azimuth estimation apparatus according to one embodiment.

Referring to FIG. 4, the geomagnetic values in the x-axis and y-axis directions, acquired while the azimuth estimation apparatus 100 is rotating, are plotted on a two-dimensional x-y plane.

When the azimuth estimation apparatus 100 is not affected by magnetic interference from nearby metallic structures, a concentric circle 430 centered at the origin may be displayed on the x-y plane.

In contrast, when the azimuth estimation apparatus is affected by magnetic interference from nearby metallic structures, the raw data 310 may appear as a distorted ellipse with its center offset from the origin.

If azimuth is estimated based on such uncorrected azimuth data 410, the reliability and accuracy of the azimuth may be relatively low. Therefore, correction may be applied to the raw data.

In one embodiment, the azimuth estimation apparatus 100 may perform an operation to shift the center of the raw azimuth data 410 to the origin, thereby obtaining first corrected data 420. This operation may be, for example, a hard iron compensation process.

The azimuth estimation apparatus may further perform an operation to convert the first corrected data 420 into a concentric circle, thereby obtaining second corrected data 430. This operation may correspond to a soft iron compensation process.

Based on the corrected geomagnetic values obtained through the above-described correction processes, the azimuth is calculated at each rotation angle to generate the basic azimuth data set.

Referring again to FIG. 2, in step S3130, the basic azimuth data set is shifted by a predetermined interval to generate multiple training azimuth data sets. That is, the azimuth data corresponding to the first rotation angle (0°) in the basic azimuth data set is shifted to the next rotation angle (e.g., 1° or 356°), thereby generating shifted versions of the basic azimuth data set.

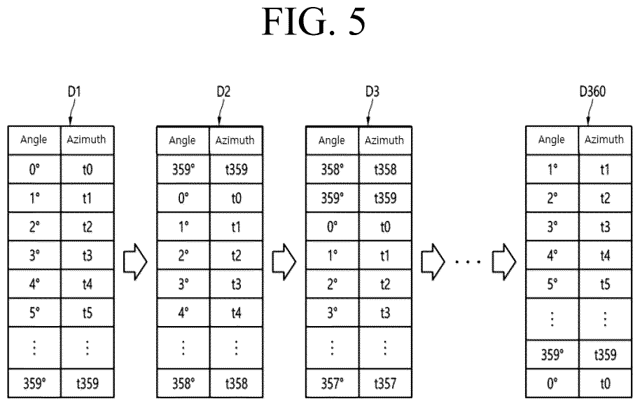

A method of generating multiple training azimuth data sets by shifting the basic azimuth data set will now be described with reference to FIG. 5. FIG. 5 is a diagram showing training data used to train the azimuth estimation model according to one embodiment. Referring to FIG. 5, the training data for the azimuth estimation model may include a first training data set to a 360th training data set (D1-D360).

The first training data set D1 (e.g., the basic azimuth data set) may include a set of azimuth values derived from geomagnetic values acquired by the azimuth estimation apparatus 100 while rotating one full turn at an arbitrary location. Specifically, the apparatus samples the acquired geomagnetic values at 1° intervals and corrects them, then calculates azimuth values based on the corrected geomagnetic values. This corresponds to the azimuth data set generated in step S3120.

As shown in FIG. 5, the data sets including the basic azimuth data set (D1 to D360) associate each angle (rotation angle) with a corresponding azimuth value.

Here, the angle may represent the rotation angle of the azimuth estimation apparatus 100 at the first location 201. Alternatively, the angle may correspond to a true azimuth. The true azimuth is calculated by adding the rotation angle to the initial azimuth of the azimuth estimation apparatus. The initial azimuth may be received from a related server through the communication interface. These angle values may be used as labels during neural network training.

The azimuth may be calculated using Equation 1 and may be included as part of the training data.

The azimuth estimation apparatus 100 may shift the basic training azimuth data set (e.g., the first azimuth data set D1) by a predetermined angle to generate multiple azimuth data sets that include the shifted azimuths.

For example, based on the basic training azimuth data set, the azimuth estimation apparatus may obtain a second data set D2 that includes azimuths shifted by 1° by rotating the data such that the data corresponding to 359° is moved to the 0° position. In other words, the azimuth data at the first rotation angle (0°) in the basic data set is replaced by the azimuth data at the next rotation angle (1° or 356°), and the entire data is shifted by 1°. In a similar manner, the azimuth estimation apparatus may obtain 360 data sets (D1-D360).

The azimuth estimation apparatus 100 may use the first to 360th data sets (D1-D360) as training data for the azimuth estimation model.

In one embodiment, the azimuth estimation apparatus increases the quantity of training data by generating shifted data sets based on an initially acquired data set, thereby improving the reliability of the azimuth estimation model.

The method of generating the training data sets described above may be summarized as follows. For example, each data set may be constructed using the following steps:
(1) Determine the initial orientation azimuth of the azimuth estimation apparatus.
(2) Rotate one full turn at the measurement location and acquire sensor data.
(3) Sample geomagnetic sensor values at 1° intervals based on acceleration and gyroscope data during rotation.
(4) At each rotation angle, update the orientation azimuth by adding the rotation angle to the initial orientation azimuth, and treat this as the true azimuth.
(5) Construct the first training data set D1 including, for each rotation angle from 0° to 359°, the true azimuth, geomagnetic sensor data, and the azimuth calculated from the geomagnetic values.
(6) After constructing the first training data set as described above, rotate all data in D1 by 1° to construct the second training data set D2. That is, the azimuth estimation apparatus may obtain a shifted data set by shifting D1 by a predetermined angle. For example, D2 may be generated by rotating D1 by 1°, such that the 359° data is moved to the 0° position.
(7) Repeat step 6 multiple times to construct 360 training data sets. That is, the azimuth estimation apparatus may obtain 360 data sets (D1-D360).

The 360 data sets generated at a single location may be used to train the neural network. In other words, the azimuth estimation apparatus may use the first to 360th data sets (D1-D360) as training data for the azimuth estimation model.

In the present embodiment, the training data sets are constructed using a maximum azimuth of 360°, but in other embodiments, the azimuth may exceed 360°. For instance, the training data sets may be expanded to cover up to 370° or more.

Referring again to FIG. 2, in step S2140, the generated azimuth data sets D1 to D360 are used to generate and train the azimuth estimation model.

The processor 110 may train a neural network-based azimuth estimation model using the generated azimuth data sets D1 to D360.

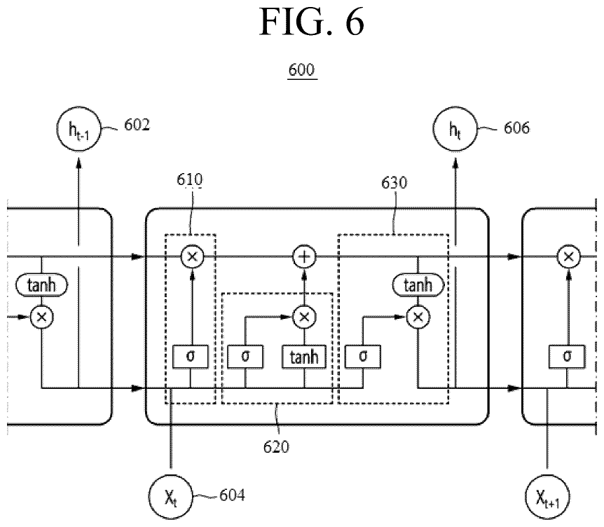

The azimuth estimation model may be based on at least one of a convolutional neural network (CNN), a recurrent neural network (RNN), or a long short-term memory (LSTM) model. Details of the LSTM model are described in FIG. 6.

In one embodiment, the processor 110 may train the azimuth estimation model based on the initialized rotation angle of the azimuth estimation apparatus 100. The processor 110 may set the rotation angle to align with the initial azimuth.

For example, if the initial azimuth is east, the rotation angle may be set to 90° to align with the azimuth, thereby enabling the data to be used for training. This method may be applicable regardless of whether the azimuth estimation apparatus 100 acquires geomagnetic values while rotating in place or while moving.

FIG. 6 is a diagram for explaining the operation of an azimuth estimation model of the azimuth estimation apparatus according to an embodiment. Referring to FIG. 6, the azimuth estimation model of the azimuth estimation apparatus 100 employs a long short-term memory (LSTM) model 600.

However, the invention is not limited thereto, and the azimuth estimation model may be based on at least one of a convolutional neural network (CNN), a recurrent neural network (RNN), or an LSTM model. The LSTM model 600 addresses the issue of forgetting earlier inputs when processing long sequences during training-a known limitation of conventional RNNs.

The cell of the LSTM model 600 may include a forget gate 610, an input gate 620, and an output gate 630.

The forget gate 610 may receive the previous cell's output value 602 and the current cell's input value 604, and determine whether to discard the previous output 602 using a sigmoid function.

The input gate 620 may determine which new information should be stored in the cell state. The input gate 620 may use a combination of a sigmoid function and a tanh function to select relevant data.

The LSTM model 600 may combine the output of the forget gate 610 with the output of the input gate 620. The output gate 630 may apply a sigmoid function to the input value 604 and determine which value to output 606 from the cell state.

For example, the neural network-based azimuth estimation model may include 360 input nodes, each corresponding to data associated with one of the rotational angles included in the training data set. The model is trained by minimizing the difference between the measured azimuth and the estimated azimuth. Once training is complete, each edge of the model will have a specific weight.

Referring again to FIG. 2, in step S3150, the trained azimuth estimation model is stored in memory.

In another embodiment, the trained azimuth estimation model may be provided to another apparatus. For example, in response to a request received via the communication interface from another terminal or an external server, the azimuth estimation model may be transmitted to that external entity.

The following describes the azimuth estimation operation in greater detail. That is, if the input signal indicates an azimuth estimation operation (S3020—Estimate) in step S3020, the following steps are performed.

In step S2300, the azimuth estimation apparatus 100 fetches the trained azimuth estimation model. The trained model may be stored in the memory of the azimuth estimation apparatus 100. In this case, the model is fetched from memory. Alternatively, if the model is stored in a related server or another terminal, a request signal may be sent to retrieve the corresponding azimuth estimation model.

In step S3210, the azimuth estimation apparatus identifies its current orientation at a given location (e.g., second location 202) and performs a 360-degree rotation from the current orientation to acquire acceleration values, angular velocity values, and geomagnetic values corresponding to different directions.

In step S3220, the azimuth estimation apparatus calculates rotation angle values based on the acquired acceleration and angular velocity values and obtains sampled geomagnetic values by sampling the geomagnetic data at specific rotation angles.

In step S3230, the azimuth estimation apparatus corrects the sampled geomagnetic values according to a predefined method to obtain corrected geomagnetic values. Based on the corrected values, the apparatus estimates the azimuth at each rotation angle and generates an azimuth estimation data set based on the estimated azimuth values.

In step S3240, the azimuth estimation apparatus applies the estimated azimuth data set to the fetched azimuth estimation model to estimate the final azimuth.

The estimated azimuth data set includes information measured at 1-degree intervals from the apparatus's orientation angle, such as mₓ, m_{y}, m_{z}, and the calculated azimuth value derived from −tan⁻¹(m_{y}/mₓ). The data associated with each rotation angle in the estimated azimuth data set is input into the 360 input nodes of the trained azimuth estimation model, and the trained model outputs a geomagnetic azimuth as a real-valued result.

In step S3250, the estimated azimuth is provided. For example, the estimated azimuth may be displayed via an input/output circuit or transmitted and delivered to a designated terminal or server through a communication interface.

In another embodiment, declination (magnetic deviation) information may be stored in an associated server. The server may use this stored declination information to correct the azimuth. For instance, the azimuth estimation apparatus 100 may transmit a request message including its current location to the associated server and receive the corresponding declination information. The apparatus 100 may then correct the estimated azimuth using the received declination. The azimuth estimation apparatus and method described above can generate a wide variety of training data through data augmentation based on sampling and rotation, thereby improving the accuracy and reliability of the neural network-based azimuth estimation model. The technology of the present disclosure is applicable to a wide range of mobile or fixed devices, including smartphones, wearable devices, robots, drones, and autonomous vehicles.

According to one embodiment of the present disclosure, a plurality of azimuth data sets can be generated to effectively train the azimuth estimation model using a neural network. In order to enhance the generalization performance of the neural network, training data collected under various conditions, rather than data biased toward a particular azimuth, is required. To achieve this, the azimuth estimation apparatus may rotate in place by 360 degrees, sampling geomagnetic sensor values at 1-degree intervals to collect uniformly distributed data.

In addition, by sequentially rotating (shifting) the original data set collected at a single location by 1 degree increments, a total of 360 data sets can be created. This allows for the generation of directionally diverse training data from a single set of raw data. Such a data augmentation technique is advantageous for improving both learning efficiency and reliability.

To assign accurate labels (true azimuths) to each collected sample, it is essential to know the initial azimuth at the start of data collection. This initial azimuth can be obtained using precise compasses, maps, or astronomical observations. The subsequent rotation angle of the apparatus can be estimated with reasonable accuracy using inertial sensors (accelerometers and gyroscopes). Inertial sensors are unaffected by magnetic disturbances and exhibit minimal drift error over short durations such as during in-place rotation, making them well-suited for cumulative rotation angle estimation.

The generated training data can be used to train the neural network model, and the trained model can estimate the azimuth by inputting a single data set collected at a new location. The azimuth estimation approach may be based on regression or classification. In the case of regression, the neural network directly outputs the azimuth as a real number. In the case of classification, the network outputs a probability distribution over all angles from 0 to 359 degrees, and the angle with the highest probability is selected as the final azimuth.

In the classification approach, if the output probability is lower than a predetermined threshold, the estimation result may be disregarded, and data may be re-collected at the same location or re-estimated after moving to an adjacent location. This approach is applicable not only when the apparatus is stationary but also while it is in motion.

Furthermore, the azimuth estimation model of the present invention may be utilized in apparatuses that track movement trajectories. For example, while conventional trajectory tracking devices estimate rotation direction using image sensors or inertial sensors, applying the azimuth estimation model of the present invention in combination can enhance the accuracy of rotation direction or azimuth estimation. Particularly, in classification-based azimuth estimation, when the output probability is high, the corresponding azimuth may be given greater weight and prioritized over other sensor data. In regression-based estimation, the output may be combined with other sensor data at an appropriate ratio to enable more stable direction estimation. This weighting ratio may be dynamically adjusted based on differences among sensors or deviations from previous estimations.

The azimuth estimation apparatus and method of the present embodiment can be applied in various fields. For instance, the apparatus and method of the present invention may be embedded in mobile communication terminals (e.g., smartphones) or other mobile devices (e.g., vehicles, mobile robots, etc.) carried by users to identify accurate azimuth. The invention may also be implemented in unmanned devices (e.g., drones), utilizing azimuth information to perform functions such as autonomous navigation, control, or collision avoidance. Additionally, the invention may be integrated into VR (Virtual Reality), AR (Augmented Reality), or MR (Mixed Reality) devices to estimate direction or azimuth in real time while the user is moving.

The invention may also be applied in autonomous vehicles, where accurately identifying the vehicle's heading is critically important-especially in high-speed turning zones where rapid and precise guidance at road or lane level on digital maps is required. If geomagnetic sensor data can be applied to a neural network to accurately estimate azimuth, the vehicle's rotation angle or heading can also be accurately determined, thereby greatly contributing to the safety of autonomous driving. Moreover, the apparatus and method of the present invention may be mounted in transceiver devices to enhance communication efficiency. For example, if a transceiver device can accurately calculate azimuth using the present technology, it can adjust the antenna polarization of the counterpart device in alignment with its own orientation, thereby significantly improving communication efficiency during transmission between two or more transceivers.

Electromagnetic waves generally consist of electric and magnetic fields, with the electric field carrying relatively more energy. Therefore, when transmitting and receiving antennas are aligned in the same direction rather than perpendicular to each other, the signal strength can be tens of times greater. Proper antenna alignment is thus a critical factor for improving data transmission speeds, reducing communication errors, conserving power, and extending battery life.

This alignment method can be implemented by allowing each transceiver device to estimate its own azimuth and adjust its device or antenna orientation either in the same direction or in the opposite direction (180 degrees) accordingly. This approach is applicable to both stationary and mobile communication devices and is also effective for communication between terminals and base stations or between terminals and communication satellites.

The apparatus and method of the present invention may also be used to reduce communication interference when embedded in transceiver devices. By accurately estimating the azimuth, the device can adjust the direction of its antenna to minimize interference.

For example, to reduce interference with a specific transceiver device, the antenna direction may be adjusted to be perpendicular to that of the interfering device. This allows for improved communication efficiency with the intended transceiver, thereby enhancing the utilization of frequency resources.

Furthermore, antenna alignment occurs in three-dimensional space rather than in just two dimensions. Therefore, using direction information based on three-dimensional geomagnetic sensor data is more effective than relying on simple two-dimensional azimuth. Because the received signal strength can vary significantly depending on the antenna's radiation pattern and the relative position between transceiver devices, optimal antenna alignment considering relative positioning, antenna directionality, and azimuth can maximize overall performance in communication networks.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An azimuth estimation apparatus comprising:
a memory storing instructions; and
a processor operably coupled to the memory and configured to execute the instructions,
wherein, when the instructions are executed by the processor, the processor is configured to perform a plurality of operations, the plurality of operations comprising:
acquiring an acceleration value, an angular velocity value, and geomagnetic values in different directions of the azimuth estimation apparatus while the azimuth estimation apparatus rotates at a first location;
obtaining a rotation angle value of the azimuth estimation apparatus based on the acceleration value and the angular velocity value;
acquiring sampled geomagnetic values by sampling the geomagnetic values based on the rotation angle value;
estimating an azimuth at the first location based on the sampled geomagnetic values;
calculating a true azimuth by adding the rotation angle to an initial azimuth of the azimuth estimation apparatus at the first location;
training a neural network-based azimuth estimation model based on the sampled geomagnetic values and the estimated azimuth; and
estimating an azimuth at a second location using the trained azimuth estimation model.

2. The azimuth estimation apparatus of claim 1, wherein the plurality of operations further comprises obtaining corrected geomagnetic values by correcting the geomagnetic values,
wherein the acquiring sampled geomagnetic values comprises sampling the corrected geomagnetic values at predetermined angle intervals during rotation of the azimuth estimation apparatus based on the rotation angle value to obtain the sampled geomagnetic values.

3. The azimuth estimation apparatus of claim 1, wherein the plurality of operations further comprises obtaining a data set including geomagnetic values and azimuth values that are shifted by a predetermined angle based on the sampled geomagnetic values, and
wherein the training a neural network-based azimuth estimation model comprises training the neural network-based azimuth estimation model based on the sampled geomagnetic values, the data set, and the azimuth values.

4. The azimuth estimation apparatus of claim 1, wherein the plurality of operations further comprises measuring an accuracy of the azimuth at the second location based on the trained neural network-based azimuth estimation model.

5. The azimuth estimation apparatus of claim 1, wherein the different directions include a first direction, a second direction, and a third direction that are perpendicular to each other.

6. The azimuth estimation apparatus of claim 1, wherein the neural network-based azimuth estimation model is based on at least one of a convolutional neural network (CNN) model, a recurrent neural network (RNN) model, or a long short-term memory (LSTM) model.

7. The azimuth estimation apparatus of claim 1, wherein the acquiring an acceleration value, an angular velocity value, and geomagnetic values comprises acquiring the acceleration value, angular velocity value, and geomagnetic value of the azimuth estimation apparatus while the azimuth estimation apparatus rotates during movement.

8. The azimuth estimation apparatus of claim 1, wherein the training a neural network-based azimuth estimation model comprises training the neural network-based azimuth estimation model based on an initialized rotation angle of the azimuth estimation apparatus.

9. A method for estimating an azimuth, performed by an azimuth estimation apparatus, comprising:
acquiring an acceleration value, an angular velocity value, and a geomagnetic value for different directions of the azimuth estimation apparatus while the azimuth estimation apparatus rotates at a first location;
acquiring a rotation angle value of the azimuth estimation apparatus based on the acceleration value and the angular velocity value;
acquiring sampled geomagnetic values by sampling the geomagnetic value based on the rotation angle value;
estimating an azimuth at the first location based on the sampled geomagnetic values;
training a neural network-based azimuth estimation model based on the sampled geomagnetic values and the azimuth; and
estimating an azimuth at a second location using the trained neural network-based azimuth estimation model.

10. The method of claim 9, further comprising acquiring corrected geomagnetic values by correcting the geomagnetic values,
wherein the acquiring sampled geomagnetic values comprises sampling the corrected geomagnetic values at predetermined rotation angle intervals while the azimuth estimation apparatus rotates, based on the rotation angle value.

11. The method of claim 9, further comprising acquiring a dataset including geomagnetic values and azimuth values that are shifted by a predetermined angle based on the sampled geomagnetic values,
wherein the training a neural network-based azimuth estimation model comprises training the neural network-based azimuth estimation model based on the sampled geomagnetic values, the dataset, and the azimuth.

12. The method of claim 9, further comprising measuring an accuracy of the azimuth at the second location based on the trained azimuth estimation model

13. The method of claim 9, wherein the different directions comprise a first direction, a second direction, and a third direction that are orthogonal to each other.

14. The method of claim 9, wherein the neural network-based azimuth estimation model is based on at least one of a convolutional neural network model, a recurrent neural network model, or an LSTM (long short-term memory) model.

15. The method of claim 9, wherein the acquiring an acceleration value, angular velocity value, and geomagnetic value comprises acquiring the acceleration value, angular velocity value, and geomagnetic value of the azimuth estimation apparatus while the azimuth estimation apparatus rotates during movement.

16. The method of claim 9, wherein the training a neural network-based azimuth estimation model comprises training the neural network-based azimuth estimation model based on an initialized rotation angle of the azimuth estimation apparatus.
